(19) United States
(12) Patent Application Publication
(10) Pub. No.: US 2013/0043303 A1
(43) Pub. Date: Feb. 21, 2013

(54) ELECTRONIC TRANSACTION SYSTEM

(71) Applicant: Gi Gi CHEN, Taipei (TW)

(72) Inventor: Gi Gi CHEN, Taipei (TW)

(21) Appl. No.: 13/482,645

(22) Filed: May 29, 2012

(30) Foreign Application Priority Data
Aug. 16, 2011 (TW) 100129299

(51) Int. Cl. G06Q 20/36; G06Q 20/34

(52) U.S. Cl. 235/379

(57) ABSTRACT

The present invention is related to an electronic transaction system, particularly to an electronic transaction system which is able to use a variety of cards or tags, and is free from being misappropriated and skimmed. The system comprises a server, a plurality of terminals and a plurality of characteristic code carriers. The server is provided with a member database for storing account information, amount of electronic cash and a characteristic code of each member. Each terminal is connected to the server via a network, and is used for payment, top up value, consumption inquiry, account creation, changing or stopping the characteristic code carrier and etc.

### FIELD OF THE INVENTION

The present invention is related to an electronic transaction system, particularly to an electronic transaction system which is able to use a variety of cards or tags, and is free from being misappropriated and skimmed.

### BACKGROUND

An electronic wallet is a means of payment tool commonly used by the customer in business activities, such as means of payment in small value purchase or purchasing small-value commodity. Nowadays, the electronic transaction system is being built in many countries all over the world, for replacing the model of cash transaction.

Referring to FIG. 1, there is shown a diagram illustrating the condition using a conventional electronic wallet. The electronic wallet is developed from an integrated circuit card (IC card). It is an IC card 16 with value top-up function, i.e., the card is provided therein with an IC 161 for data access. The IC card 16 is stored with a value of cash or other electronic currencies by banks or the user, and can be used for payment at a point of sale (POS) system 12 installed with the same electronic wallet system.

In general, the POS system 12 comprises a display 121, a keyboard 123 and a card reader 14. After the IC card 16 is inserted into the card reader 14, information of electronic cash stored in the IC 161 can be read by the POS system 12. The cashier uses the keyboard 123 to select the function of the POS system 12, such as deduction of amount due to payment, increase in amount of top-up value, consumption inquiry and etc. Moreover, the operations are displayed on the display 121 for the reviewing of the user. After confirmation, updated information of electronic cash is then written into the IC 161 of the IC card 16.

In some electronic wallet systems, a radio frequency identification (RFID) card is adopted as a carrier of the electronic cash. In this case, the card is provided with a RFID tag for storing data related to electronic cash. In such a system, an RFID tag reader is used for data access of the RFID tag in the RFID card. The other operations are similar to those of the above-mentioned IC card system.

In the aforementioned electronic wallet system, a plastic card can be used to replace cash transaction for small value commodity or service. But systems adopted by shops are incompatible. For different shops, different cards are needed for electronic wallet transaction. Thus, it is not convenience for the user to take along many cards and not environment friendly to produce such amount of cards.

In addition, the cards used in most electronic wallet systems belong to bearer cards, which equivalent to cash. If the card gets lost, it may be retrieved with little chance. Therefore, there still exists considerable risk for the current electronic wallet system.

Near Field Communication (NFC) technology is introduced by companies. It is necessary for NFC technology to dispose an NFC control chip, an antenna, and a secure element for anti-interference in a smart phone. An application program for controlling system operation and data access is also needed to be installed in the smart phone. In point of the application of electronic wallet, the security of transaction may be enhanced. But the cost of smart phones, used as the carriers necessarily, themselves is too high. Moreover, the tangible and intangible cost due to the increase in elements and the modification of the circuit structure of the smart phone, needed for the operation of the NFC technology, may result in a significant effect on popularity.

### SUMMARY OF THE INVENTION

It is one object of the present invention to provide an electronic transaction system, particularly to an electronic transaction system, which is able to use a variety of cards or tags, and free from being misappropriated and skimmed.

It is a further object of the present invention to provide an electronic transaction system, which comprises a server for storing account information and amount of electronic cash of a member, and a plurality of terminals verifying identities of members via characteristic codes before shopping, toping up and etc. Thereby, electronic cash belonging to the member is ensured.

It is a further object of the present invention to provide an electronic transaction system, which verifies identities of members by means of characteristic code carriers, and access passwords inputted by members on shopping. Thereby, dual verification for the guarantee of electronic transaction may be provided.

It is a further object of the present invention to provide an electronic transaction system, wherein the terminals can be integrated into the POS systems of shops or service providing units for facilitating bookkeeping integration and shopping.

It is a further object of the present invention to provide an electronic transaction system, in which a member can open an account by inputting a member code at a terminal, and providing a characteristic code carrier for a characteristic code reader to read the characteristic code.

It is a further object of the present invention to provide an electronic transaction system, wherein a password is sent to the member by means of one of short message, e-mail, post, printing, voice and the combination thereof selectively, by the server after the account is created.

It is a further object of the present invention to provide an electronic transaction system, wherein the member code is selectively one of a national identity number, a passport number, a phone number, a mobile phone number, an e-mail address, a business registration number, a user defined account, a specific account and the combination thereof.

It is a further object of the present invention to provide an electronic transaction system, wherein the member is requested by the server to input and confirm a password of account when the account is created.

It is a further object of the present invention to provide an electronic transaction system, wherein the characteristic code carrier is selectively one of an IC card, an RFID card, an RFID tag, a bar code, a two-dimensional bar code, a quick response (QR) code, a magnetic stripe card and the combination thereof.

It is a further object of the present invention to provide an electronic transaction system, wherein the characteristic code reader is selectively one of an IC card reader, an RFID tag reader, a bar code reader, a two-dimensional bar code reader, a QR code reader, a magnetic stripe card reader and the combination thereof.

It is a further object of the present invention to provide an electronic transaction system, wherein the characteristic code carrier is selectively one of an identification card, a health insurance card, an Easycard, an cash card, a Taiwan Smart Card, an All-in-One Card, a credit card, a debit card, a cash card, a traffic card, an Octopus card and a member card.

It is a further object of the present invention to provide an electronic transaction system, wherein each member can log in the server through network for account management, consumption inquiry, and changing or stopping the characteristic code carrier.

The present invention provides an electronic transaction system comprising: a server provided with a member database for storing account information, amount of electronic cash, and characteristic codes of a plurality of members; a plurality of terminals connected to said server through a network, wherein each of the terminals is provided with a display, an operation keyboard, a characteristic code reader and a member keyboard; and a plurality of characteristic code carriers corresponding to each account respectively, wherein each of the characteristic code carriers comprises a characteristic code; wherein said members carry the corresponding characteristic code carriers having the characteristic codes to be read by the characteristic code reader of the terminal, and input a password via the member keyboard, so as to conduct an activity of one of shopping payment, toping up value, consumption inquiry and the combination thereof, the corresponding amount of electronic cash of the member account in the server is updated automatically when the amount is changed.

In one embodiment of the present invention, wherein each of the terminals is integrated into a point of sale (POS) system of a shop or a service providing unit.

In one embodiment of the present invention, wherein the terminal is operated with a function of account creation by the operation keyboard, and a user inputs a member code and provides the characteristic code carrier having the characteristic code to be read by the characteristic code reader, in such a way that an account is created in the server.

In one embodiment of the present invention, wherein said member code is selectively one of a national identity number, a passport number, a phone number, a mobile phone number, an e-mail address, a business registration number, a user defined account, a specific account, a bar code or the combination thereof

In one embodiment of the present invention, wherein the password of said account is sent to the member by means of one of short message, e-mail, post, printing, voice and the combination thereof selectively by said server, when said member account is created.

In one embodiment of the present invention, wherein the member is requested by said server to input and then confirm the password of said account via said member keyboard, when said account is created.

In one embodiment of the present invention, wherein said characteristic code carrier is selectively one of an IC card, a radio frequency identification (RFID) card, an RFID tag, a bar code, a two-dimensional bar code, a quick response (QR) code, a magnetic stripe card or the combination thereof.

In one embodiment of the present invention, wherein said characteristic code reader is selectively one of an IC card reader, an RFID tag reader, a bar code reader, a two-dimensional bar code reader, a QR code reader, a magnetic stripe card reader or the combination thereof.

In one embodiment of the present invention, wherein said characteristic code carrier is selectively one of an identification card, a health insurance card, an Easycard, an cash card, a Taiwan Smart Card, an All-in-One Card, a credit card, a debit card, a cash card, a traffic card, an Octopus card or a member card.

In one embodiment of the present invention, wherein each of the members can log in to the server through a network for account management, consumption inquiry, and changing or stopping the characteristic code carrier.

In one embodiment of the present invention, wherein each of the members can change or stop the characteristic code carrier by inputting the member code and the password to the terminal, and operating the terminal with a function of changing or stopping the characteristic code carrier.

In one embodiment of the present invention, wherein the member database of said server further stores records of consumptions and toping up values corresponding to each account.

In one embodiment of the present invention, wherein the display and the operation keyboard of each of the terminals are integrated as a touch panel.

### BRIEF DESCRIPTION OF DRAWINGS

FIG. 1 is a diagram illustrating the condition using a conventional electronic wallet.

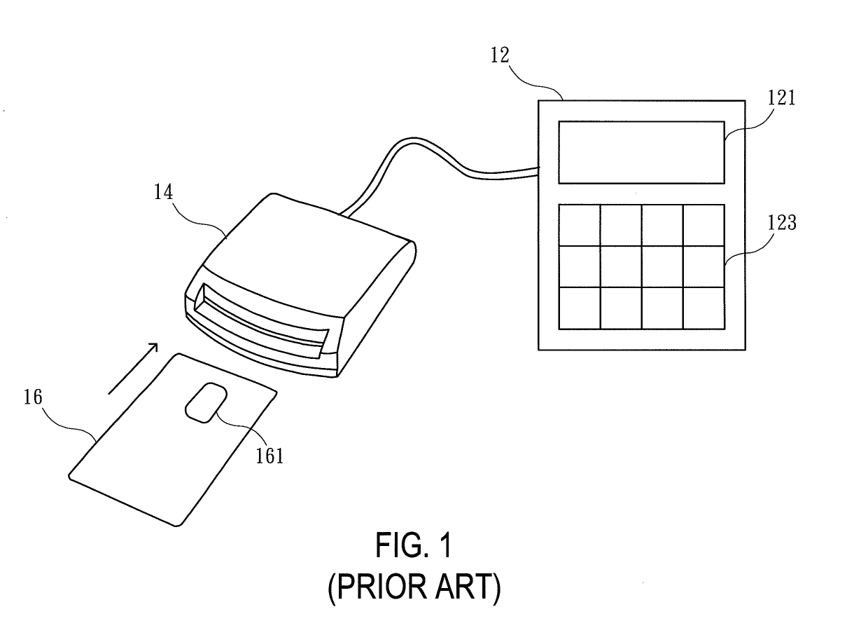

FIG. 2 is a diagram illustrating an electronic transaction system in accordance with one embodiment of the present invention.

### DETAILED DESCRIPTION

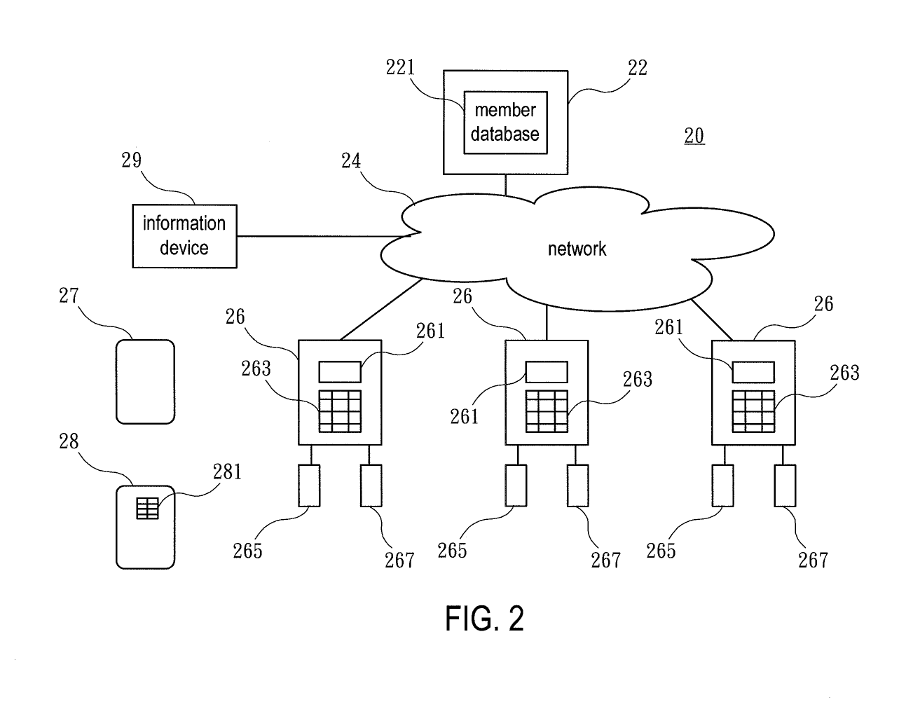

Referring to FIG. 2, there is shown a diagram illustrating an electronic transaction system in accordance with one embodiment of the present invention. As illustrated in this figure, the electronic transaction system 20 of the present invention comprises a server 22, a plurality of terminals 26 and a plurality of characteristic code carriers. Each of the terminals 26 is connected to the server 22 through a network 24.

Since a variety of cards or tags comprises an unique characteristic code, such as an IC card 28, a radio frequency identification card (RFID card) 27 or other types of RFID tag, a bar code, a two-dimensional bar code, quick response code (QR code) and a magnetic stripe card, it is possible for the present invention to use cards or tags owned by a user himself as the characteristic code carrier. The characteristic code stored in the characteristic code carrier is served as a basis for identifying membership quickly. Naturally, a new characteristic code carrier may be also provided by a system provider, if it is required by a member.

The server 22 of the present invention is provided with a member database 221 for storing account information, the amount of electronic cash and the characteristic code of each member.

Each of the terminals 26 is provided with a display 261, an operation keyboard 263, a characteristic code reader 265 and a member keyboard 267. The operation keyboard 263 is used by an operator to operate the terminal 26, or select each function of the terminal 26, such as shopping payment, top-up value, consumption inquiry, account creation, changing or stopping the characteristic code carrier and etc.

When a user desires to apply for membership of the electronic transaction system 20 of the present invention, he/she can make an application at a site where the terminal 26 is provided. Firstly, an operator selects the function of account creation on the terminal 26 by using the operation keyboard 263. Subsequently, a member code is inputted by the operator or the user himself, and then the characteristic code reader 265 is served for reading the characteristic code stored in the characteristic code carrier (such as an RFID card 27 or an IC card 28) provided by the user or system. Thereby, an account is then created in the server 22.

A password of the account may be sent to the member by means of short message, e-mail, post, printing or voice selectively by the server 22 while the account is created. Alternatively, the member is requested by the server to input and then confirm a password via the member keyboard 267 at the terminal 26 directly.

A user can also use an information device 29 (such as a computer, a notebook, a smart phone, a tablet personal computer, an pad, a personal digital assistant and etc.) To connect to the server 22 via the network. After the function of account creation is selected, the member code is inputted to create an account. After the account is created, the server 22 may also send a password of the account to the member by means of short message, e-mail, post, printing or voice. After the above steps are completed, it is required for the member to go to the site where the terminal 26 is provided. The member inputs the member code and the password via the member keyboard 267, and provides a characteristic code carrier having a characteristic code to be read by the characteristic code reader 265. After the characteristic code is stored in the member database 221, the procedure of account creation is then complete.

After the account is created, a member can uses an information device 29, such as a computer, a mobile phone, a smart phone, a notebook, a tablet personal computer, an pad, a personal digital assistant and etc., to connect to the server 22 via the network, and then log in the account with a corresponding password. Thereby, the activity, such as account management, consumption inquiry, changing or stopping of characteristic code carrier and etc., may be conducted.

If the payment with the electronic transaction system 20 is desired by the member after shopping, the operator uses the operation keyboard 263 to select the function of payment. Subsequently, the member provides the characteristic code carrier (27 or 28), and the characteristic code stored in the characteristic code carrier (27 or 28) is read by the characteristic code reader 265 for membership identification. The transaction is directed to the corresponding account. After the password is inputted by the member via the member keyboard 267, the payment is deducted from amount deposited in this account. If toping up value and inquiry of consumption are required, the member can go through the above steps with required functions.

In case of the characteristic code carrier being broken or lost, the member can to go to the site where the terminal 26 is provided, and select the function of changing characteristic code carrier via the operation keyboard 263. By inputting the member code and the password and then providing a new characteristic code carrier (27 or 28), a new characteristic code is read by the characteristic code reader 265, moreover, the process of changing characteristic code carrier is then completed.

Each step of the above operation process can be displayed on the display 261 for the reviewing of the member.

In one embodiment of the present invention, each terminal 26 may be integrated into the point of sale (POS) system of the shop or service providing unit, for facilitating the integration of payment and bookkeeping. The records of shopping and top-up value corresponding to each account may be also stored in the member database 221 of the server 22 for the inquiry of the member, shop, service providing unit or related bookkeeper.

In one embodiment of the present invention, the member code used by the user for the account creation is selected from one of a national identity number, a passport number, a phone number, a mobile phone number, an e-mail address, a business registration number, a user defined account, a specific account, a bar code and the combination thereof. For the creation of account, any one of an IC card 28, an RFID card 27, an RFID tag, A bar code, A two-dimensional bar code, A QR code or a magnetic stripe card owned by the user himself can be used as the characteristic code carrier, such as current identification card, health insurance card, Easycard, cash card, Taiwan Smart Card, All-in-One Card, credit card, debit card, cash card, traffic card, Octopus card, member card, other types of carriers having characteristic codes therein and etc. Further, the terminal 26 of the present invention is provided with a corresponding characteristic code reader 265, such as IC card reader, RFID tag reader, bar code reader, two-dimensional bar code reader, QR code reader, magnetic stripe card reader and etc, thereby the characteristic code of the corresponding characteristic code carrier can be read.

In one embodiment of the present invention, the display 261 and the operation keyboard 263 of the terminal 26 may be also integrated into a touch panel.

By using the electronic transaction system 20 of the present invention, the effect of energy saving and carbon-reducing can be improved. In the present invention, the electronic cash in the electronic transaction system belonging to the member is ensured, and is free from being misappropriated and skimmed.

The foregoing description is merely one embodiment of the present invention and not considered as restrictive. All equivalent variations and modifications in shape, structure, feature, and spirit in accordance with the appended claims may be made without in any way from the scope of the invention.

1. An electronic transaction system comprising:
a server provided with a member database for storing account information, amount of electronic cash, and characteristic codes of a plurality of members;
a plurality of terminals connected to said server through a network, wherein each of the terminals is provided with a display, an operation keyboard, a characteristic code reader and a member keyboard; and
a plurality of characteristic code carriers corresponding to each account respectively, wherein each of the characteristic code carriers comprises a characteristic code;
wherein said members carry the corresponding characteristic code carriers having the characteristic codes to be read by the characteristic code reader of the terminal, and input a password via the member keyboard, so as to conduct an activity of one of shopping payment, toping up value, consumption inquiry and the combination thereof, the corresponding amount of electronic cash of the member account in the server is updated automatically when the amount is changed.

2. The electronic transaction system according to claim 1, wherein each of the terminals is integrated into a point of sale (POS) system of a shop or a service providing unit.

3. The electronic transaction system according to claim 1, wherein the terminal is operated with a function of account creation by the operation keyboard, and a user inputs a member code and provides the characteristic code carrier having the characteristic code to be read by the characteristic code reader, in such a way that an account is created in the server.

4. The electronic transaction system according to claim 3, wherein said member code is selectively one of a national identity number, a passport number, a phone number, a mobile phone number, an e-mail address, a business registration number, a user defined account, a specific account, a bar code or the combination thereof

5. The electronic transaction system according to claim 4, wherein the password of said account is sent to the member by means of one of short message, e-mail, post, printing, voice and the combination thereof selectively by said server, when said member account is created.

6. The electronic transaction system according to claim 4, wherein the member is requested by said server to input and then confirm the password of said account via said member keyboard, when said account is created.

7. The electronic transaction system according to claim 1, wherein said characteristic code carrier is selectively one of an IC card, a radio frequency identification (RFID) card, an RFID tag, a bar code, a two-dimensional bar code, a quick response (QR) code, a magnetic stripe card or the combination thereof

8. The electronic transaction system according to claim 7, wherein said characteristic code reader is selectively one of an IC card reader, an RFID tag reader, a bar code reader, a two-dimensional bar code reader, a QR code reader, a magnetic stripe card reader or the combination thereof

9. The electronic transaction system according to claim 1, wherein said characteristic code carrier is selectively one of an identification card, a health insurance card, an Easycard, an cash card, a Taiwan Smart Card, an All-in-One Card, a credit card, a debit card, a cash card, a traffic card, an Octopus card or a member card.

10. The electronic transaction system according to claim 1, wherein each of the members can log in to the server through a network for account management, consumption inquiry, and changing or stopping the characteristic code carrier.

11. The electronic transaction system according to claim 10, wherein each of the members can change or stop the characteristic code carrier by inputting the member code and the password to the terminal, and operating the terminal with a function of changing or stopping the characteristic code carrier.

12. The electronic transaction system according to claim 2, wherein the member database of said server further stores records of consumptions and toping up values corresponding to each account.

13. The electronic transaction system according to claim 1, wherein the display and the operation keyboard of each of the terminals are integrated as a touch panel.
